(19) United States
(12) Patent Application Publication
(10) Pub. No.: US 2007/0102269 A1
(43) Pub. Date: May 10, 2007

(54) Drive for switching device

(76) Inventor: Werner Hartmann, Weisendorf (DE)

Correspondence Address: HARNESS, DICKEY & PIERCE, P.L.C., P.O.BOX 8910, RESTON, VA, 20195, US

(21) Appl. No.: 10/573,825

(22) PCT Filed: Sep. 29, 2004
(86) PCT No.: PCT/EP04/10902

§ 371 Date: Mar. 29, 2006

(30) Foreign Application Priority Data
Sep. 30, 2003 (DE) 10345502.7

(51) Int. Cl. H01H 35/26; H01H 35/24

(52) U.S. Cl. 200/81 R

(57) ABSTRACT

In a drive for a switching device, stored energy is converted into a rapid switching movement and a switching body is hence activated. An energy conversion occurs as a result of an underwater electrical discharge, by the application of stored electrical energy in order to evaporate a drive medium, by which an exclusive pressure is generated for operating the switching body. An advantage is presented of the possibility of the complete recondensation/recombination of the working medium and a greatly increased lifespan compared to a conventional explosive drive.

This application is the national phase under 35 U.S.C. § 371 of PCT International Application No. PCT/EP2004/010902 which has an International filing date of Sep. 29, 2004, which designated the United States of America and which claims priority on German Patent Application No. 103 45 502.7 filed Sep. 30, 2003, the entire contents of which are hereby incorporated herein by reference.

### FIELD

The invention generally relates to a drive for a switching device. For example, it may relate to one in which stored energy is converted to a rapid switching movement, and a switching member is activated.

### BACKGROUND

Drives with a high switching speed are required in the field of medium-voltage switching devices for specific purposes such as the prevention of fault arcs. In this case the aim is to initiate a switching operation electronically and to end it within a few milliseconds, in order to limit the fault arc energy. Drive principles with a high drive power and energy are required for this purpose.

In the past, the following drive principles, which each have specific characteristics, have been used:
spring storage drive: problems can occur in the event of rapid unlatching and owing to material fatigue by creepage or the like.
magnetic drive: this drive is relatively slow owing to the high moving masses of the drive.
electromagnetic eddy current drive: long movements are difficult to achieve with a drive such as this.
explosion drive: one major problem in this case is the short life (typically 1× up to max. ≈10×).

In particular, the latter explosion drives are known in a different embodiment. For example, DE 35 45 327 describes a drive such as this which operates with an explosive gas mixture. DE 102 05 369 A1 and DE 297 23 872 U1 includes switching elements such as these, in which pyrotechnic materials are used in order to interrupt the circuit. Similar drive devices are known from GB 2 016 210 A and from US 3 700 970 A, in which, in the case of devices such as these, the arc is blown with a quenching medium at the same time, in addition to rapid opening of the contacts.

### SUMMARY

An object of at least one embodiment of the invention is to provide an improved drive for a switching device.

According to at least one embodiment of the invention, and in contrast to the prior art, no explosion drive is provided. In fact, a drive is provided which operates on the basis of a spark discharge, in particular an underwater spark discharge, in which electrically stored energy is used. A suitable drive medium, for example water or else other suitable liquid or gaseous medium is thus made to heat very rapidly—in the sub-millisecond range to the millisecond range—and to be vaporized, with the gas pressure that is produced explosively during this process being used to drive a switching contact.

All of the drive energy which is required for the switching operation is in this case supplied electrically; this method is therefore reversible, apart from wear phenomena, the number of switching operations is not restricted as in the case of other methods, in which a limited number of pyrotechnic propellant charges must be kept available, and thus limit the number of possible switching operations. The spark gap which is required for energy conversion can be kept with no voltage applied to it throughout the entire operating period, and is briefly loaded with voltage only during a tripping process, so that inadvertent self-initiation is impossible. If required, an additional high-voltage pulse can be passed to an auxiliary electrode via an auxiliary voltage, in order to assist and/or to speed up the initiation process, and to reduce the natural scatter of the initiation process. In the case of inductive decoupling of the main discharge circuit, this auxiliary initiation pulse can also be passed directly to one of the main electrodes, so that there is no need for an auxiliary electrode.

Advantages of at least one embodiment of the invention may include, in particular, repetition capability for complete recondensation/recombination of the working medium, a considerably longer life than in the case of an explosion drive, the lack of any need for replacement and/or storage of explosive cartridges. The drive energy can in some circumstances be taken directly from the 230 V power supply, depending on the configuration of the switching gap and the requirement for the disconnection time, so that no energy storage is required.

A further particular advantage of at least one embodiment of the invention is that the tripping process is carried out completely electronically—that is to say without any electromechanically moving parts—so that no additional mechanical tripping delay need be taken into account. The switching process for voltages of several hundred V and peak currents of a few 100 A to 1000 A with a current flow duration in the region of a few milliseconds can be coped with by semiconductor switching elements such as thyristors and IGBTs, so that there is no need for components that are sensitive to ageing, such as vacuum interrupters or electromechanical auxiliary switches.

### BRIEF DESCRIPTION OF THE DRAWINGS

Further advantages and details of the invention will become evident from the following description of the figures of example embodiments on the basis of the drawings, in conjunction with the patent claims. In the figures:

FIG. 1 shows the principle of the invention applied to a vacuum switch, and

FIGS. 2/3 show a high-speed switch which is operated electrohydraulically by a driver shown in FIG. 1, with a closing function, both in the open state and in the closed state.

### DETAILED DESCRIPTION OF THE EXAMPLE EMBODIMENTS

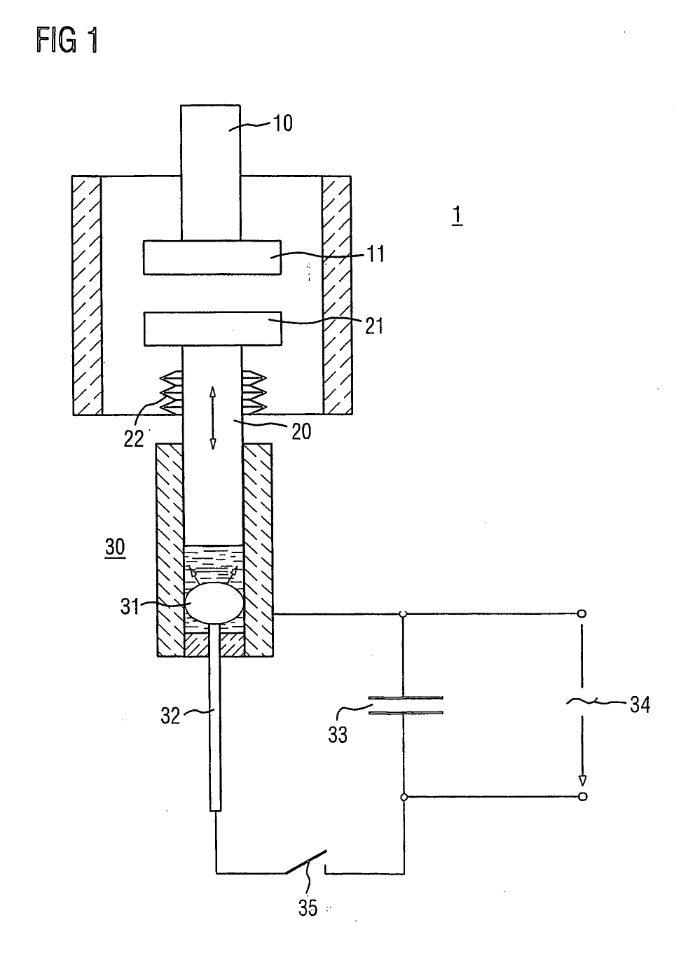

In FIG. 1, 1 denotes a vacuum interrupter in which a fixed contact is arranged fixed above a fixed contact bolt. A moving contact is arranged opposite this, via a contact bolt which can be moved axially. The moving contact is moved via a drive from the illustrated “open” position to the “closed” position.

The illustration in FIG. 1 shows an advantage of the drive according to at least one embodiment of the invention over a known explosive-driven drive. The explosive-filled detonation capsule according to the prior art is in this case replaced by a pressure vessel 30 which is filled with a suitable medium, in particular water. Fluids, in particular liquids such a water as has already been mentioned, or else inert gases, such as nitrogen or argon, may be used as media. The fluid may contain additives which conduct ions.

A pressure wave similar to an explosion wave is produced in this fluid medium by initiation of a spark discharge, and drives the moving contact BK towards the fixed contact, in the illustrated case. A corresponding switching operation is thus carried out, to be precise closing of the contact system in the case shown in FIG. 1, which switching operation is reversible once the vaporized medium has cooled down/recondensed, so that a longer mechanical life can be achieved.

As shown in FIG. 1, the electrical energy can be provided, for example, via an electrical energy store in the form of a capacitor, the switch shown in the figure may be in the form of an IGBT or a power MOSFET, or else a thyristor with a freewheeling diode. In one particularly advantageous arrangement, the electrical peak power is so small (a few 10 kW) that it can be taken directly from the 230 V power supply in the form of the permissible short-circuit load. For example, with a mass of 2 kg to be operated, a required contact travel of 15 mm and a switching time of 5 ms the required energy is only about 120 VAs, in which case an efficiency for conversion of electrical energy to mechanical energy of 30% can actually be assumed; the associated electrical power of about 24 kW is coped with by modern semiconductors and in some circumstances can be taken directly from the power supply. Otherwise a storage capacitance of 2.5 mF is required for a typical energy store charging voltage of 311 V (corresponding to the amplitude of the 230 V power supply, on the assumption of full-wave bridge rectification).

When the switch is initiated, a sufficiently high voltage is built up on the spark gap that an electrical flashover occurs in the drive medium; during this process, a sufficiently large amount of energy is subsequently absorbed in the drive medium that it may be vaporized and is then heated to such an extent that the thermodynamic pressure that is produced during this process is sufficient to operate the moving contact.

Corresponding to the prior art, devices are provided in order if appropriate to latch the moving contact in its limit position, in accordance with the requirements, and to move it back again to its initial position. This can be achieved, for example, by mechanical latching or else by permanent magnets.

In order to reduce the unavoidable initiation delay in the case of the overvoltage initiation of the spark gap as used in the described example, and to overcome static fluctuations, it is advantageous in at least one embodiment, to use a separate auxiliary initiation circuit with a higher initiation voltage. The additional, low-energy tripping pulse can in this case first of all result in the breakdown of a particle discharge path via an additional trigger electrode, which is then followed by the main spark gap after a short initiation delay of only a few microseconds.

Alternatively, the voltage-side electrode of the main discharge circuit can be inductively decoupled from the main discharge circuit for high frequencies, so that a high-frequency, high-voltage auxiliary pulse can be coupled directly to the spark electrode, leading to the spark gap breaking down with little delay.

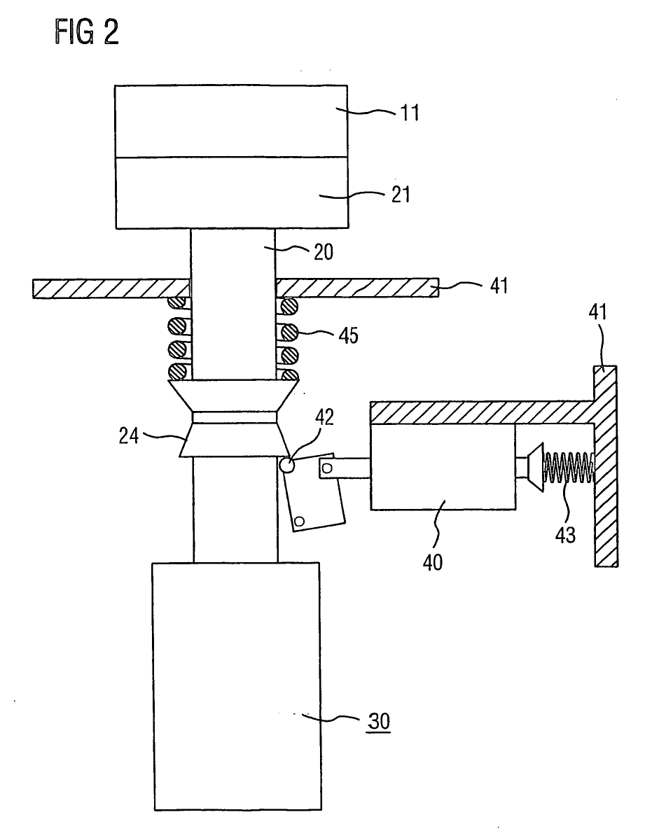

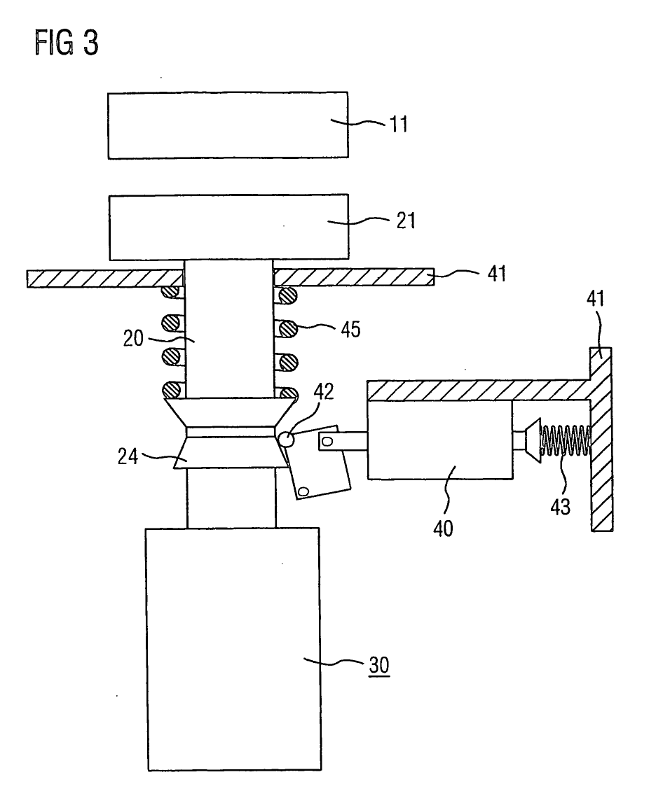

In FIGS. 2 and 3, the electrohydraulic drive as described above in detail with reference to FIG. 1 is annotated overall by 30. This acts on an axially moving bolt, with a mechanical latching/unlatching mechanism 40 being provided in a manner known per se. The latching/unlatching mechanism 40 is attached to a holding plate 41, which is arranged in a fixed position, such that it can move with respect to a latching spring 42 and, via a catch 43, acts on the axially moving bolt 20 with a holding element 24 for the catch 42. An opening spring 45 is provided, shown in the loaded form in FIG. 2 and in the unloaded form in FIG. 3.

In FIG. 2, the electrohydraulically driven moving contact 21 is shown in the closed, mechanically latched position. In this case, the opening spring 45 provided according to the prior art is already loaded. The energy for loading the opening spring 45 in the illustrated exemplary embodiment is applied by the electrohydraulic drive 30, 31, 32 as shown in FIG. 1. On operation of the unlatching mechanism 40, the catch 42 is released, and the loaded opening spring 45 moves the moving contact 21 back to the (open) initial state.

FIG. 3 shows the electrohydraulically driven moving contact 21 in the open, mechanically unlatched position, in which the opening spring 45 is unloaded.

Instead of the mechanical latching mechanism described with reference to FIGS. 2 and 3, it is also possible to provide latching/unlatching devices which operate magnetically, with electromagnets being suitable for this purpose.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A drive for switching devices, in which stored energy is converted to a rapid switching movement for activation of a switching member, the device comprising:
means for operating the switching member using a gas pressure produced at least one of directly and indirectly; and
means for using controlled energy conversion on the basis of a spark discharge, in which electrical energy at least one of stored and taken from the power distribution power supply, to vaporize a fluid via an electrical discharge, a gas pressure produced by the vaporization process acting as a drive medium on the switching member.

2. The drive as claimed in claim 1, wherein the fluid is water.

3. The drive as claimed in claim 2, wherein the fluid contains ion-conductive additives.

4. The drive as claimed in claim 1, having a spark gap, arranged within the fluid, for energy conversion, the spark gap not being live during operation of the switching device and being loaded briefly with voltage only for the process of tripping the switching member.

5. The drive as claimed in claim 4, further comprising means for production of a high-voltage pulse, the high-voltage pulse being passed to an auxiliary electrode of the spark gap.

6. The drive as claimed in claim 5, wherein the high-voltage pulse is produced by a voltage source with a parallel-connected capacitor.

7. The drive as claimed in claim 5, wherein the auxiliary electrode has an associated switch.

8. The drive as claimed in claim 7, wherein the switch is a semiconductor switch, in particular an IGBT, power MOSFET or thyristor.

9. The drive as claimed in claim 5, further comprising means for nductive injection of the high-voltage pulse.

10. The drive as claimed in claim 1, further comprising means for latching/unlatching the axially moving bolt with the moving contact.

11. The drive as claimed in claim 9, wherein the latching/unlatching means operate mechanically.

12. The drive as claimed in claim 9, wherein the latching/unlatching means operate magnetically.

13. The drive as claimed in claim 10, wherein the energy for latching is applied by the electrohydraulic drive.

14. (canceled)

15. The drive as claimed in claim 7, wherein the switch is at least one of an IGBT, power MOSFET and thyristor.

16. The drive as claimed in claim 11, wherein the energy for latching is applied by the electrohydraulic drive.
